(19) United States
(12) Patent Application Publication
(10) Pub. No.: US 2008/0027926 A1
(43) Pub. Date: Jan. 31, 2008

(54) DOCUMENT SUMMARIZATION METHOD AND APPARATUS

(76) Inventors: Qian Diao, Beijing (CN); Jiulong Shan, Beijing (CN)

Correspondence Address: SCHWABE, WILLIAMSON & WYATT, P.C., PACWEST CENTER, SUITE 1900, 1211 S.W. FIFTH AVE., PORTLAND, OR, 97204, US

(21) Appl. No.: 11/461,336

(22) Filed: Jul. 31, 2006

(51) Int. Cl. G06F 17/30

(52) U.S. Cl. 707/5

(57) ABSTRACT

Apparatuses, methods, and systems associated with and/or having components capable of, summarizing electronic documents are disclosed herein.

### TECHNICAL FIELD

Embodiments of the invention relate generally to the field of data processing, specifically to methods, apparatuses, and systems associated with summarizing electronic documents.

### BACKGROUND

In the field of information retrieval, various search methodologies have been used to assist a user in sorting through an array of electronic documents to find electronic documents relevant to the user's search. Various search engines may find and rank electronic documents based on maximizing relevance to the user's query, yet these search engines may still require the user to sort through hundreds (or more) of closely-related electronic documents to locate the relevant sections of text. To that end, a method to summarize the electronic documents would be highly useful. Hereinafter, including the claims, unless the context clearly indicates otherwise, for ease of understanding electronic documents will simply be referred to as documents, and the two terms are to be considered synonymous.

Currently, there are several methods for summarizing documents. For example, graph-based ranking is a summarization algorithm using random walk theory that has been used for document summarization. This ranking method determines the sentence(s) that are central to the topic of the document according to their similarity to other sentences in the document; i.e., the method considers global patterns of similarities between sentences of the document. Computation of similarities between sentences may be performed using any one of a variety of similarity calculation algorithms, including, for example, cosine similarity. However, this method may not be oriented to a query and thus may not capture a degree of similarity between the query and the sentences of the summary. Furthermore, this method may fail to consider sentence redundancy in a summary result.

Another summarization method is Maximal Marginal Relevancy (MMR). MMR algorithm is a query-based algorithm; i.e., MMR takes into account similarity of sentences to the query. Furthermore, MMR may take into account similarity of sentences to already-selected sentences. Specifically, sentences that are chosen for inclusion in a summary may maximally similar to the query and maximally dissimilar to already-selected sentences. Accordingly, MMR may minimize the redundancy associated with graph-based ranking. However, MMR may fail to take into account the main topic of documents thus yielding an incomplete and/or low-quality summary result.

### BRIEF DESCRIPTION OF THE DRAWINGS

Embodiments of the present invention will be readily understood by the following detailed description in conjunction with the accompanying drawings. Embodiments of the invention are illustrated by way of example and not by way of limitation in the figures of the accompanying drawings.

FIG. 1 illustrates a document summarization method incorporated with the teachings of the present invention, in accordance with various embodiments;

FIG. 2 illustrates an article of manufacture incorporated with the teachings of the present invention, in accordance with various embodiments; and

FIG. 3 illustrates a document summarization system incorporated with the teachings of the present invention, in accordance with various embodiments.

### DETAILED DESCRIPTION OF EMBODIMENTS OF THE INVENTION

In the following detailed description, reference is made to the accompanying drawings which form a part hereof and in which is shown by way of illustration embodiments in which the invention may be practiced. It is to be understood that other embodiments may be utilized and structural or logical changes may be made without departing from the scope of the present invention. Therefore, the following detailed description is not to be taken in a limiting sense, and the scope of embodiments in accordance with the present invention is defined by the appended claims and their equivalents.

Various operations may be described as multiple discrete operations in turn, in a manner that may be helpful in understanding embodiments of the present invention; however, the order of description should not be construed to imply that these operations are order dependent.

The description may use the phrases “in an embodiment,” or “in embodiments,” which may each refer to one or more of the same or different embodiments. Furthermore, the terms “comprising,” “including,” “having,” and the like, as used with respect to embodiments of the present invention, are synonymous.

The phrase “A/B” means “A or B.” The phrase “A and/or B” means “(A), (B), or (A and B).” The phrase “at least one of A, B and C” means “(A), (B), (C), (A and B), (A and C), (B and C) or (A, B and C).” The phrase “(A) B” means “(B) or (A B),” that is, A is optional.

In embodiments of the present invention, methods, articles of manufacture, and systems for summarizing documents are provided. A document summarization in accordance with various embodiments may comprise one or more summary sentences. Document summarization may be capable of capturing similarities between a sentence and a user's query as well as between the sentence and a main topic of a document. Thus, in embodiments, a method for document summarization may be capable of outputting relevant, yet minimally redundant, summary sentence(s) in a summarization.

In exemplary embodiments of the present invention, a computing system may be endowed with one or more components of the disclosed articles of manufacture and systems and may be employed to perform one or more methods as disclosed herein. Regarding applications for which document summarization may be enlisted, contexts in which document summarization may be used in accordance with disclosed methods is vast. For example, methods for document summarization may be performed for summarizing information on the World Wide Web. In other embodiments, methods for document summarization may be performed for summarizing other information including, but not limited to, legal documents, medical records, medical publications, etc. It will be appreciated by those of ordinary skill in the art that a wide variety of alternate applications are possible without departing from the scope of the present invention.

Methods in accordance with various embodiments may comprise conditional outputting of a summarization including one or more summary sentences. In various ones of these embodiments, summary sentence(s) may include sentence(s) of one or more documents, depending on the applications. For example, in various embodiments, a method may comprise summarizing simply one document or may variously comprise summarizing multiple documents. Further, in embodiments, a summarization may be based or limited in part by a desired and/or necessary summarization length (e.g., the number of outputted sentences).

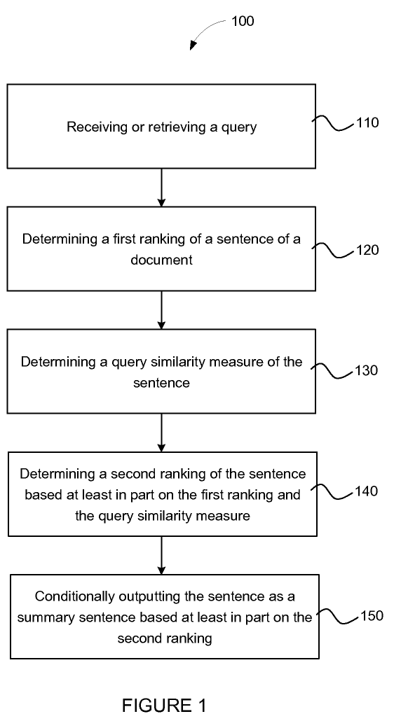

Referring now to FIG. 1, illustrated is an embodiment of a document summarization method 100 in accordance with various embodiments of the present invention. For the embodiments and as shown, method 100 may comprise receiving or retrieving by a computing apparatus a query (as shown at 110). In various ones of these embodiments, a query may be any word or string of multiple words and in some embodiments, a word or words may be selected based at least in part on some degree of relevancy to an information-seeking goal. In some applications, a query may be input by a user and may be fully open-ended (e.g., a user provides all word(s) of a query) or may be some pre-determined and/or auto-generated word(s) (e.g., a user need not provide any word(s)), or some combination of both.

A method may comprise determining a global pattern of similarities between sentences. For example, in various embodiments, a sentence that is similar to many other sentences of a document may be considered more central to the topic of the document. However, in various embodiments, sentence(s) having little or no similarity to other sentence(s) of a document may be ignored or otherwise treated accordingly.

In various exemplary embodiments, a method may comprise determining a first ranking of a sentence of a document indicative of the sentence's ranking in terms of similarity with one or more other sentences of the document (as shown at 120). In various ones of these embodiments, a sentence that is similar to many other sentences of a document may be determined to have a first ranking reflecting the centrality of the sentence(s) to the document. Similarity, in various embodiments, sentence(s) having little or no similarity to other sentence(s) of a document may be determined to have a first ranking of less (or simply a different) value as compared to sentences more central to a topic of a document.

In various embodiments, determining a first ranking of a sentence of a document may comprise calculating a rank value of the sentence. In various ones of these embodiments, a rank value may be based at least in part on one or more sentence similarity measures correspondingly measuring similarity of a sentence of a document with one or more other sentences of the document. With respect to sentence similarity measures in accordance with various embodiments, a sentence similarity measure may be variously calculated. For example, a sentence similarity measure may be calculated by calculating one or more cosine similarity measures between a sentence of a document and one or more other sentences of the document. For example, a sentence similarity measure may be calculated by computing similarity of every two sentences of a document, generating an adjacency matrix, normalizing the adjacency matrix by row, and computing a principal eigenvector of the adjacency matrix.

In various embodiments, a method may comprise determining a similarity between a sentence and a query. For example and still referring to method 100, method 100 may comprise calculating a query similarity measure measuring similarity of a sentence of a document to a query (as shown at 130). In embodiments, measuring similarity between a sentence and a query may comprise calculating a frequency of word(s) of a query in the sentence. However, other metrics may be used, depending on the applications. For example, in various embodiments, word(s) of a query may be variously weighted and thus a metric may consider determination of a frequency of word(s) of a query in a sentence weighted according to the pre-determining weight value. In various exemplary embodiments, measuring similarity of the sentence to the query may be performed using any one or more various metrics including, for example, cosine similarity.

In various embodiments, one or more sentences of a document may be ranked based at least in part on a second ranking (as shown at 140). In various ones of these embodiments, a second ranking may be based at least in part on a first ranking and a query similarity measure. In an exemplary embodiment, a second ranking may be calculated by calculating a composite rank value of a sentence. A composite rank value may be based at least in part on a weighted contribution of a selected one of a sentence similarity measure(s) and a query similarity measure qualified by a rank value. A query similarity measure may be so qualified by a rank value by multiplying a query similarity measure by a normalized version of the rank value. Normalization for a sentence of a document may be variously performed including, for example, by dividing a rank value by the largest of the rank value and one or more other rank values similarly computed for one or more other sentences of the document. In various ones of these embodiments, normalization may result in a normalized rank value between 0 and 1.

Methods in accordance with various embodiments may comprise outputting a sentence as a summary sentence. As mentioned previously, a summarization (or part of a summarization) may comprise one or more summary sentences. In various embodiments, a sentence may be conditionally outputted as a summary sentence based at least in part on a first ranking and a query similarity measure. In exemplary embodiments, a sentence may be conditionally outputted as a summary sentence based at least in part on its second ranking (as shown at 150).

The previously discussed exemplary methods for document summarization are not limited to the outputting of single-summary sentence summarizations. In various embodiments, methods for document summarization may comprise performing any one or more of 110, 120, 130, 140, and 150 for one or more other sentences of a document. In exemplary embodiments, a method may comprise calculating a third ranking for another sentence of a document, and determining another query similarity measure measuring similarity of the other sentence to a query. Still further, in various ones of these embodiments, another sentence may be conditionally output as another summary sentence based at least in part on a third ranking and another query similarity measure. For example and similarly to methods previously discussed, another sentence may be conditionally output as another summary sentence based at least in part on a fourth ranking, wherein the fourth ranking may be based at least in part on a query similarity measure of the other sentence qualified by a third ranking.

Still further, methods for document summarization in accordance with various embodiments are not limited to single-document summarization. For example, one or more sentences of one or more other documents (i.e., second, third, etc., document(s)) may be summarized and in various ones of these embodiments, summarization of multiple documents may incorporate various features of the previously discussed methods. For example, in an exemplary embodiment and similarly to methods previously discussed, a method may comprise determining a third ranking for another sentence of another document indicative of the other sentence's similarity to other sentences of the other document, and determining another query similarity measure measuring similarity of the other sentence to the query. In various ones of these embodiments, a fourth ranking may be determined based at least in part on the other query similarity measure qualified by the third ranking, and the other sentence may be conditionally outputted as another summary sentence based at least in part on the fourth ranking.

In various embodiments wherein more than one summary sentence is outputted, second and additional summary sentence(s) may be variously conditionally outputted. For example, in various embodiments, a second summary sentence may be conditionally outputted based at least in part on similarity of a sentence of a document to another sentence of another document. For example, in various embodiments, a method may comprise determining similarity of an already-outputted summary sentence to another sentence, and in various ones of these embodiments, the other sentence may be conditionally outputted as another summary sentence based at least in part on the similarity. In various embodiments, conditionally outputting of a sentence as another summary sentence may be based at least in part on a maximal dissimilarity of the sentence to the already-outputted summary sentence(s). Outputting additional summary sentence(s) having a maximal dissimilarity may result in minimization of redundancy in a summarization comprising a plurality of summary sentences.

Methods in accordance with various embodiments of the present invention may be represented by any one of various equations. For example, in an exemplary embodiment, a method for document summarization may be performed in accordance with the following algorithm for scoring a sentence Sᵢ of a group of sentences Sₖ (e.g., all sentences of one or more documents), using a query Q:

$$Score ( {S}_{i} ) = λ \cdot rank ( {S}_{i} ) ( constant + Sim ( {{V}_{S}}_{i} , {V}_{Q} ) ) - ( 1 - λ ) {max}_{{S}_{k} ∈ R} Sim ( {{V}_{S}}_{i} , {V}_{{S}_{k}} )$$

In the exemplary algorithm, λ may be an empirical value, and R may be the sentence(s) already outputted as summary sentence(s) and may be defined as null prior to the outputting of a first summary sentence. The constant may be any number and may be used to prevent a 0 result in the first part of the equation (e.g., in exemplary embodiments, 0.001 may be used). In addition, rank(S) is a normalization equation and may be defined as follows:

$$rank ( {S}_{i} ) = \frac{Rank ( {S}_{i} )}{{max}_{i = 1}^{N} ( Rank ( {S}_{i} ) )}$$

wherein N is the number of sentences in a document, Sⱼ is a sentence(s) of group of sentences Sₖ having non-zero similarities with sentence Sᵢ, and:

$$Rank ( {S}_{i} ) = ( 1 - d ) + d \cdot {\sum }_{{S}_{j} ∈ Neighbors ( {S}_{i} )} \frac{Sim ( {V}_{{S}_{j}} , {V}_{{S}_{i}} )}{{\sum }_{{S}_{k} ∈ Neighbor ( {S}_{j} )} Sim ( {V}_{{S}_{j}} , {V}_{{S}_{k}} )}$$

### In various embodiments of the exemplary algorithm, similarities (Sim) may be computed by any known similarity metric including, for example, cosine similarity.

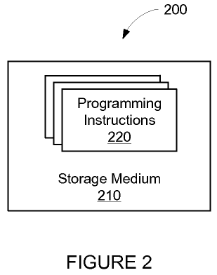

In exemplary embodiments of the present invention, articles of manufacture and/or systems may be employed to perform one or more methods as disclosed herein. For example, an article of manufacture may be adapted to enable an apparatus to summarize one or more documents. In an exemplary embodiment as shown in FIG. 2, an article of manufacture 200 may comprise storage medium 210 and plurality of programming instructions 220 stored in the storage medium. In various ones of these embodiments, programming instructions 220 may be adapted to program an apparatus to enable an apparatus to summarize one or more documents according to various methods in accordance with the present invention. Storage medium 210 may take a variety of forms including, but not limited to, volatile and persistent memory, such as, but not limited to, compact disc read-only memory (CDROM) and flash memory.

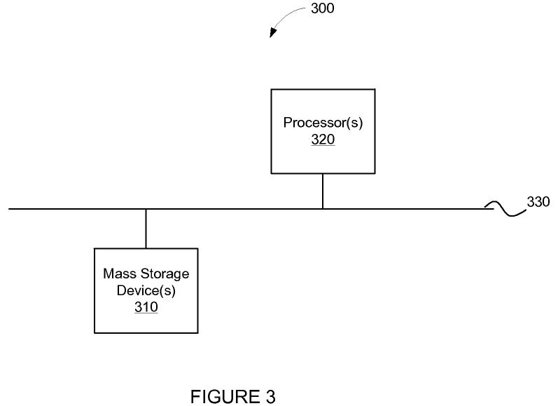

FIG. 3 illustrates a system 300 in accordance with various embodiments. As shown, system 300 may comprise one or more mass storage devices 310 and one or more processors 320 coupled to mass storage device(s) 310 via bus 330. System 300 may further comprise one or more networking interfaces (not shown) coupled with one or more processors 320 via bus 330. Processor(s) 320 may be adapted to summarize one or more documents in accordance with various embodiments of methods as disclosed herein. Mass storage device(s) 310 may take a variety of forms including, but are not limited to, a hard disk drive, a compact disc (CD) drive, a digital versatile disk (DVD) drive, a floppy diskette, a tape system, and so forth. In particular, mass storage device(s) 310 include programming instructions implementing all or selected aspects of the earlier-described embodiments of methods of the invention. In embodiments, system 300 may comprise a user interface to input a query and/or display a summary sentence(s). In various embodiments, system 300 may be a database server implementing all or selected aspects of the earlier-described embodiments of methods of the invention.

In various embodiments, system 300 may be a fully integrated unit or may comprise a number of separate components that may be coupled or otherwise associated with each other. Furthermore, in embodiments endowed with a user interface, the user interface may comprise any one or more various software programs to aid in one or more of data acquisition, data storage, operation and/or control, and/or other various functions.

Although certain embodiments have been illustrated and described herein for purposes of description of the preferred embodiment, it will be appreciated by those of ordinary skill in the art that a wide variety of alternate and/or equivalent embodiments or implementations calculated to achieve the same purposes may be substituted for the embodiments shown and described without departing from the scope of the present invention. Those with skill in the art will readily appreciate that embodiments in accordance with the present invention may be implemented in a very wide variety of ways. This application is intended to cover any adaptations or variations of the embodiments discussed herein. Therefore, it is manifestly intended that embodiments in accordance with the present invention be limited only by the claims and the equivalents thereof.

What is claimed is:

1. A method, comprising:
receiving or retrieving by a computing apparatus a query;
determining by the computing apparatus a first ranking of a sentence of a document indicative of the sentence's ranking in terms of similarity with one or more other sentences of the document;
determining by the computing apparatus a query similarity measure measuring similarity of the sentence of the document to the query;
determining by the computing apparatus a second ranking value of the sentence of the document based at least in part on the query similarity measure qualified by the first ranking; and
conditionally outputting by the computing apparatus the sentence as a summary sentence based at least in part on the second ranking value of the sentence.

2. The method of claim 1, wherein said determining of the first ranking comprises calculating a rank value based at least in part on one or more sentence similarity measures correspondingly measuring similarity of the sentence with one or more other sentences of the document.

3. The method of claim 2, further comprising calculating the one or more sentence similarity measures.

4. The method of claim 3, wherein said calculating of the one or more sentence similarity measures comprises calculating one or more cosine similarity measures between the sentence and the one or more other sentences.

5. The method of claim 3, wherein said determining the second ranking comprises calculating a composite rank value based at least in part on a weighted contribution of a selected one of the sentence similarity measures and the query similarity measure qualified by the rank value calculated based at least in part on the sentence similarity measures.

6. The method of claim 5, further comprising qualifying the query similarity measure by the rank value, by multiplying the query similarity measure by a normalized version of the rank value.

7. The method of claim 6, further comprising normalizing the rank value by dividing the rank value by a largest one of the rank value and one or more other rank values similarly computed for one or more other sentences of the document.

8. The method of claim 1, wherein said calculating of the query similarity measure comprises calculating a cosine similarity measure between the sentence and the query.

9. The method of claim 1, further comprising:
determining by the computing apparatus a third ranking for another sentence of the document indicative of the other sentence's ranking in terms of similarity with other sentence(s) of the document;
determining by the computing apparatus another query similarity measure measuring similarity of the other sentence of the document to the query;
determining by the computing apparatus a fourth ranking of the other sentence based at least in part on the fourth ranking qualified by the third ranking; and
conditionally outputting by the computing apparatus the other sentence as another summary sentence based at least in part on the fourth ranking.

10. The method of claim 1, further comprising determining by the computing apparatus a similarity of another sentence of the document with the sentence, and conditionally outputting by the computing apparatus the other sentence of the document as another summary sentence based at least in part on the other sentence's similarity with the sentence.

11. The method of claim 1, further comprising:
determining by the computing apparatus a third ranking for another sentence of another document indicative of the other sentence's similarity to other sentences of the other document;
determining by the computing apparatus another query similarity measure measuring similarity of the other sentence of the other document to the query;
determining by the computing apparatus a fourth ranking value of the other sentence of the other document based at least in part on the other query similarity measure qualified by the third ranking; and
conditionally outputting by the computing apparatus the other sentence of the other document as another summary sentence based at least in part on the fourth ranking.

12. The method of claim 1, further comprising determining by the computing apparatus similarity of another sentence of another document to the sentence of the document, and conditionally outputting by the apparatus of the other sentence the other document as another summary sentence based at least in part on the similarity of the other sentence of the other document with the sentence.

13. The method of claim 12, wherein said conditionally outputting by the apparatus of the other sentence as another summary sentence comprises conditionally outputting the other summary sentence if the other summary sentence is maximally dissimilar to the sentence.

14. An article of manufacture, comprising:
a storage medium; and
a plurality of programming instructions stored in the storage medium adapted to program an apparatus to enable the apparatus to:
receive or retrieve a query;
determine a first ranking of a sentence of a document indicative of the sentence's ranking in terms of similarity with one or more other sentences of the document;
determine a query similarity measure measuring similarity of the sentence of the document to the query;
determine a second ranking value of the sentence of the document based at least in part on the query similarity measure qualified by the first ranking; and
conditionally output the sentence as a summary sentence based at least in part on the second ranking value of the sentence.

15. The article of manufacture of claim 14, wherein the programming instructions are further adapted to determine one or more other rankings and one or more other query similarities of another sentence of the document.

16. The article of manufacture of claim 14, wherein the programming instructions are further adapted to determine one or more other rankings and one or more other query similarities of another sentence of another document.

17. A system, comprising:
one or more mass storage devices;
one or more processors coupled to the mass storage devices, and having programming instructions to be executed by the processor(s) and adapted to enable the system to:
receive or retrieve a query;
determine a first ranking of a sentence of a document indicative of the sentence's ranking in terms of similarity with one or more other sentences of the document;
determine a query similarity measure measuring similarity of the sentence of the document to the query;
determine a second ranking value of the sentence of the document based at least in part on the query similarity measure qualified by the first ranking; and
conditionally output the sentence as a summary sentence based at least in part on the second ranking value of the sentence.

18. The system of claim 17, wherein one or more of the processors are adapted to determine the first ranking and the query similarity of a sentence of a web page.

19. The system of claim 17, wherein one or more of the processors are adapted to receive or retrieve the query from a client device, and wherein said conditionally outputting comprises providing, to the client device, the sentence as the summary sentence in response to the query.

20. The system of claim 17, wherein the system is a database server.
